(19) United States
(12) Patent Application Publication
(10) Pub. No.: US 2010/0199585 A1
(43) Pub. Date: Aug. 12, 2010

(54) SUPPORT SYSTEM FOR MOUNTING BUILDING FACADE ELEMENTS TO A FRAMEWORK

(76) Inventors: Mark Victor Stevens, Pickering (GB); Leo Garner, Stockport (GB)

Correspondence Address: JACOBSON HOLMAN PLLC, 400 SEVENTH STREET N.W., SUITE 600, WASHINGTON, DC, 20004, US

(21) Appl. No.: 12/451,391

(22) PCT Filed: May 16, 2008
(86) PCT No.: PCT/IE2008/000058

§ 371 Date: Apr. 22, 2010

(30) Foreign Application Priority Data
May 17, 2007 (IE) 2007/0358

(51) Int. Cl. E04C 2/38; F16B 25/10

(52) U.S. Cl. 52/475.1; 52/705

(57) ABSTRACT

A support system for mounting building facade elements 1 to a framework 2 comprises a plurality of spacer elements or fixings 6. An insulation body is attached to the framework 2 and a plurality of brackets 5 are used to interconnect the framework 2 and the facade elements 1. The fixings 6 are used to mount the brackets 5 to the support framework 2. In-line brackets 5 are interconnected by a linear support element 7. Loading L is applied downwardly on the brackets 5 due to gravity. The load is transmitted to a screw 11 which acts in a shear direction S. Rotational moments M₁, M₂ are resisted by the bracket connection element 7.

The invention relates to a support system for an exterior cladding system. In particular, the invention relates to a support for a rainscreen system.

Generally, a cladding or rainscreen is applied to a building frame. In one known system, a rainscreen in the form of a facade panel or board and its supports is attached to a building frame by means of a number of brackets. The purpose of the brackets is to carry the load from the facade. The load can be due to the weight of the panel and/or wind pressure. In one arrangement the brackets are inserted through pre cut holes in the insulation layer. Screws are used to fix the brackets to the substrate beneath. The length of the brackets is varied, depending on the insulation thickness and cavity required. After fitting the pre-cut holes are refilled and sealed.

There are a number of problems with conventional systems. The brackets provide a heat conductor which may adversely affect the thermal performance. The systems are also labour intensive and require an installer to carry out a number of steps for correct fitting and finishing.

Current solutions for brackets are of either generally angular or cylindrical form. Angle brackets are typically of stainless steel or aluminium construction to resist corrosion and are provided with holes for installation to the substrate and a set of attachment features for the facade support grid.

These brackets perform well structurally when fixed to a rigid substrate such as reinforced concrete or masonry. They can also be made to perform structurally adequately when fixed to timber and steel framing. Thermal performance is generally adequate when angle brackets are fastened to low conductivity substrates such as concrete and timber, but major and disproportionate heat losses can result when angle brackets are fixed to conductive materials such as steel. The insulation will also need to be cut and made good to insert the bracket. In facade applications where the cavity is freely ventilated and the facade may have open joints, it is important to be able to seal the weather resisting surface for air, water and vapour permeability. The fin projection of angle brackets is difficult to seal to membrane type barriers, and also to rigid faces that have been cut and made good. Seals applied tend to be mastic and wet applied polymer types, these have a limited life expectancy and are difficult to replace when the facade is in place. They are also very dependant on good initial workmanship in order to perform.

Cylindrical type brackets tend to be used into concrete or masonry substrates and are fixed with threaded rod cores that anchor into the substrate by mechanical or adhesive means. They are generally dependant for their resistance to vertical loads on the bending strength of the threaded bar element and the shear strength of the substrate, i.e. the threaded rod element must act as a cantilever. In some cases the rod acts as a tension element, and the cylindrical covering element is clamped back to the substrate. In this case the system relies on the rigidity of the substrate for its resistance to overturning. Where the substrate is of limited depth and rigidity, e.g. thin steel, aluminium or soft wood. Some fasteners rely on their bearing onto rigid insulation materials, this substantially limits their load carrying capacity and possibly their long term durability and function.

Thermally, the threaded rod element has a relatively large cross section for structural purposes where it acts as a cantilever: this is relatively unimportant where low conductivity substrates are concerned. Where the threaded element acts in tension, the covering element can be manufactured from low conductivity materials to give good thermal performance. Products that have small fixings and rely on the rigidity of insulation, or do not resist high vertical loads may be manufactured from low conductivity materials such as plastics for good thermal performance. These are generally used solely to install insulation materials and hold them in place.

Cylindrical elements are intrinsically simpler to seal then plate/fin elements, and can easily incorporate a sealing washer into their design.

This invention is directed towards providing a bracket with the capacity to carry relatively high vertical loads associated with the weight of facade cladding materials and horizontal wind loads, whilst minimising the thermal losses though the system when connected to a thermally conductive substrate or frame. This is combined with features to provide good leakage resistance performance to air, water and vapour, on a repeatable and easily attainable basis. The bracket provides versatility in its provision for mounting alternative materials and a variety of cavity sizes.

### STATEMENTS OF INVENTION

According to the invention there is provided a support system for mounting building facade elements to a framework, the support system comprising:
a plurality of spaced-apart brackets;
a plurality of fixings for mounting the brackets to a framework, the fixing comprising a spacer section, a frame fixing element for fixing to a framework and a bracket fixing element for fixing to the bracket: and
a facade support element fixedly interconnecting in-line brackets.

In one embodiment the frame fixing element extends from the spacer section. The frame fixing element may extend from one end of the spacer section and the spacer section comprises a flange at an opposite end.

In one case the frame fixing element is a separate component from the spacer section. The frame fixing element may be movable relative to the spacer section. In another embodiment the frame fixing element is fixed relative to the spacer section.

In another case the frame fixing element is integral with the spacer section.

In one embodiment the spacer section is at least partially hollow. The spacer section may be engageable with the bracket fixing element. For example. the spacer section may screw threadingly engageable with the bracket fixing element.

In one embodiment the frame fixing element is self penetrating through an insulation body.

In one case the frame fixing element is self drilling and self tapping.

In another embodiment the spacer section has a stiffening flange.

The support system may have a washer which is engageable with the stiffening flange.

In a further embodiment the brackets and the support element are integral in a single unit.

The invention also provides a cladding system incorporating a support system of the invention.

In another aspect the invention provides a cladding system comprising:
a support framework;
an insulation body attached to the framework;
a plurality of spaced-apart brackets;
a plurality of fixings extending through the insulation for mounting the brackets to the framework;
the fixing comprising a spacer section extending through the insulation body, a frame fixing element for fixing to the framework and a bracket fixing element for fixing to the bracket;
a support element fixedly interconnecting in-line brackets; and
facade elements mounted to the support element.

In the invention there is provided a support system comprising a number of bracket elements and spacer elements; the spacer elements comprising cylindrical spacer section. a frame fixing element and a bracket fixing element, the flanged bracket elements being interconnected by a linear support element.

The invention also provides a rainscreen support system incorporating a support system of the invention.

### BRIEF DESCRIPTION OF THE DRAWINGS

The invention will be more clearly understood from the following description thereof given by way of example only, in which:

FIG. 1 is a cross sectional view of a rainscreen system incorporating a support system of the invention;

FIG. 2 is a perspective view of part of the rainscreen system of FIG. 1;

FIG. 3 is a cross sectional view of a detail of the rainscreen system and support system of FIG. 1;

FIG. 4 is an cross sectional view of a fixing device of the system;

FIG. 5 is a cross sectional view of a spacer part of the device of FIG. 4;

FIG. 6 is an elevational view of the spacer of FIG. 5;

FIG. 7 is a cross sectional view of an alternative detail of the rainscreen and support system with an alternative fixing;

FIG. 8 is a perspective view of the fixing of FIG. 7;

FIG. 9 is a top plan view of the fixing of FIG. 8;

FIG. 10 is a side elevational view of the fixing;

FIG. 11 is cross sectional view on the line XI-XI in FIG. 9: g

FIG. 12 is a perspective view of the fixing of FIGS. 7 to 11 with a washer in place;

FIGS. 13 to 16 are views of alternative fixing devices;

FIG. 17 is a cross sectional view of another fixing device of the invention including a washer;

FIG. 18 is a perspective view of the washer of FIG. 17;

FIG. 19 is an exploded perspective view of a fixing device;

FIGS. 20 and 21 are force diagrams;

FIG. 22 is a cross sectional view of an alternative rainscreen system;

FIG. 23 is a cross sectional view of a detail of another rainscreen system;

FIGS. 24 and 25 are respectively cross sectional and elevational views of a fixing device used in the system of FIG. 23;

FIG. 26 is a perspective view of the fixing device of FIGS. 24 and 25;

FIGS. 27 to 29 are views of alternative heads of the fixing device of FIG. 13;

FIG. 30 is a perspective view of a fixing device;

FIGS. 31 to 33 are views of alternative heads of the fixing device of FIG. 15; and

FIGS. 34(a) to 34(h) illustrate various cross sectional profiles of a linear connecting element used in the system of the invention.

### DETAILED DESCRIPTION

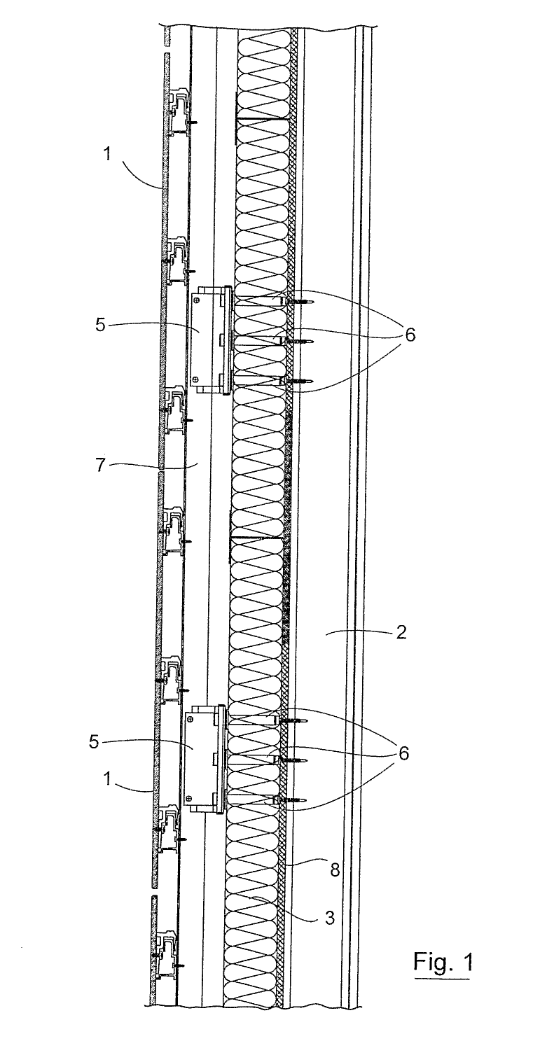

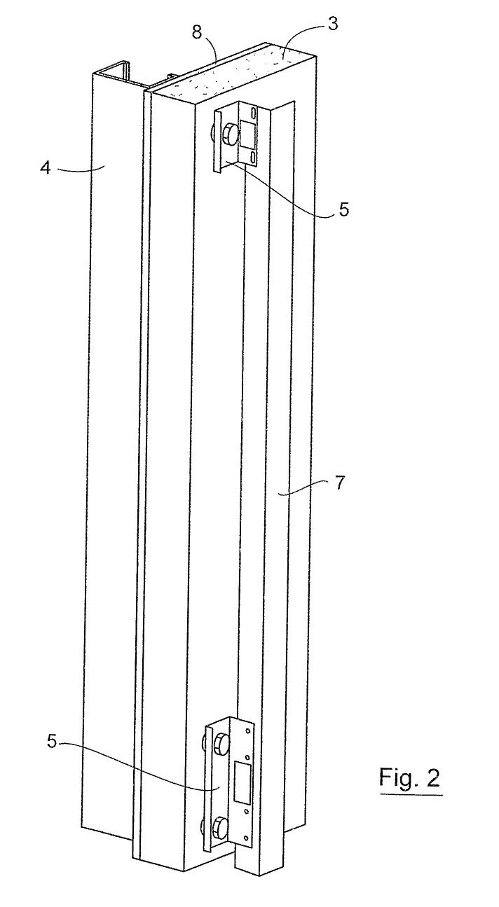

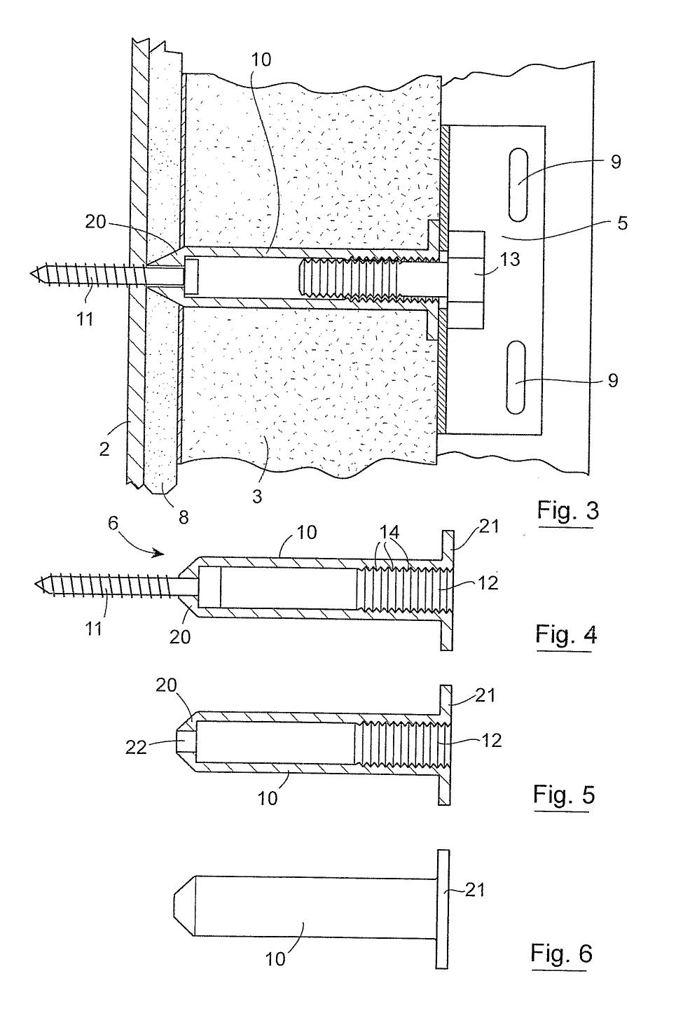

Referring to the drawings and initially to FIGS. 1 to 6 there is illustrated a support system for mounting building facade elements 1 to a framework 2. An insulation body 3 is attached to the framework 2 and a plurality of brackets 5 are used to interconnect the framework 2 and the facade elements 2. A plurality of spacer elements or fixings 6 are used to mount the brackets 5 to the support framework 2. In-line brackets 5 are interconnected by a support element 7. A sheathing board 8 may be interposed between the frame 2 and the insulation body 3. The brackets 5 may have slotted fixing holes 9 to facilitate thermal expansion

The fixing 6 comprises a generally cylindrical spacer section 10 and a frame fixing element 11 in the form of a screw for fixing to a frame 2. The spacer section 10 also defines a receiver 12 for reception of a bracket fixing 13 which may be in the form of a bolt. The spacer section 10 may be screw threaded at 14 to receive a correspondingly threaded shank of the bolt 3.

The spacer section 10 has a front end 20 which is tapered to facilitate penetration and embedding of the front end 20 in the insulation 3 and sheathing board 8 when the screw 11 is driven. At the opposite end the spacer section 10 has a stiffening flange 21 which acts as a land for the bracket 5, the bracket 5 being securely fixed to the flange 21 by the bolt 13.

In this case the frame fixing screw 11 is a separate component which is extendable through a hole 22 in the tapered end 20 of the spacer section 10. The fixing 11 is self drilling and self tapping. The screw 11 may be adapted to suit the frame 2 for improved strength.

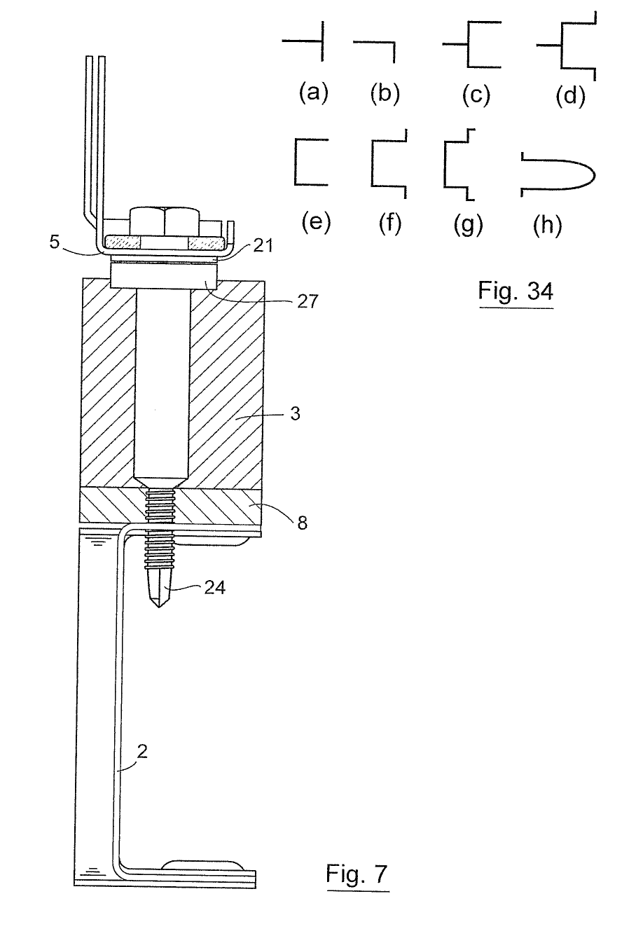

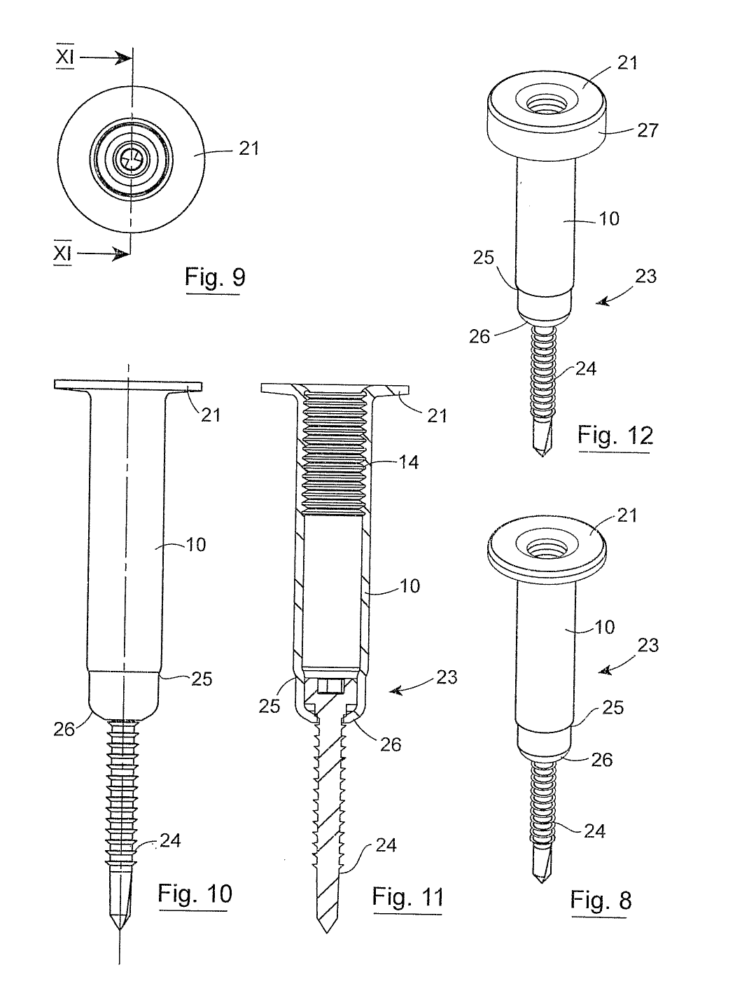

Referring to FIGS. 7 to 12 there is illustrated an alternative detail of the cladding and support system of the invention with an alternative fixing system 23 which is similar to that described above and like parts are assigned the same reference numerals. In this case the frame fixing element is a self drilling and self tapping screw 24. The frame fixing element 24 is held captive in the spacer section 10 for ease of use. The spacer section 10 has a shoulder 25 and the frame fixing end of the spacer section 10 is turned inwardly at 26 to hold the frame fixing element 24. Rotation of the frame fixing element 24 is facilitated whilst retaining the fixing element for ease of use. An external self sealing washer 27 is provided. The washer functions to create a water and air seal when the spacer is tightened into position. The seal is created between the spacer flange and the surface of the insulation.

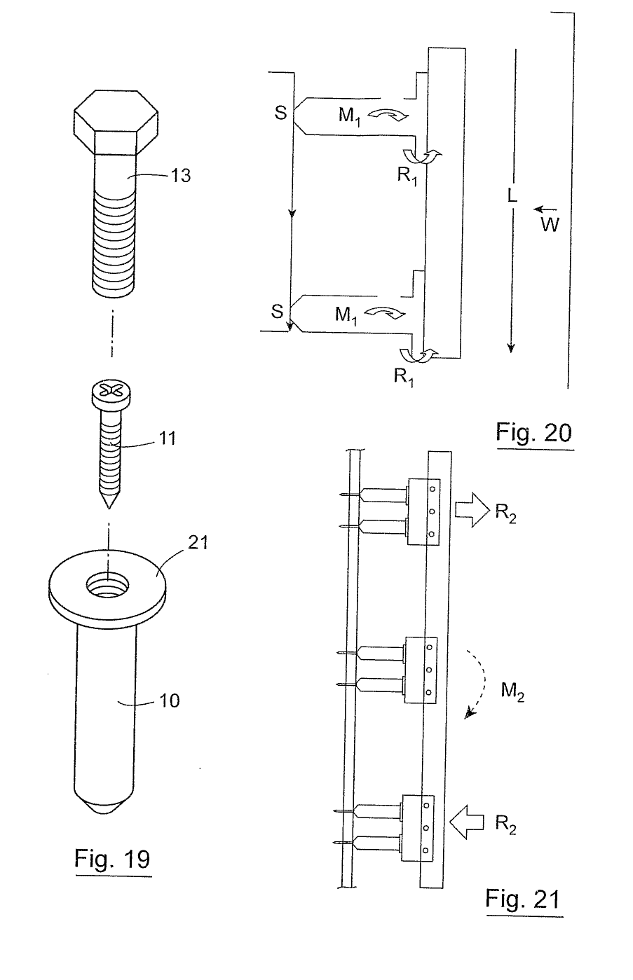

As illustrated in FIG. 19 the screw 11 may have any type of suitable driving head. For ease of use the screw may be held at least partially captive at the tapered end 20.

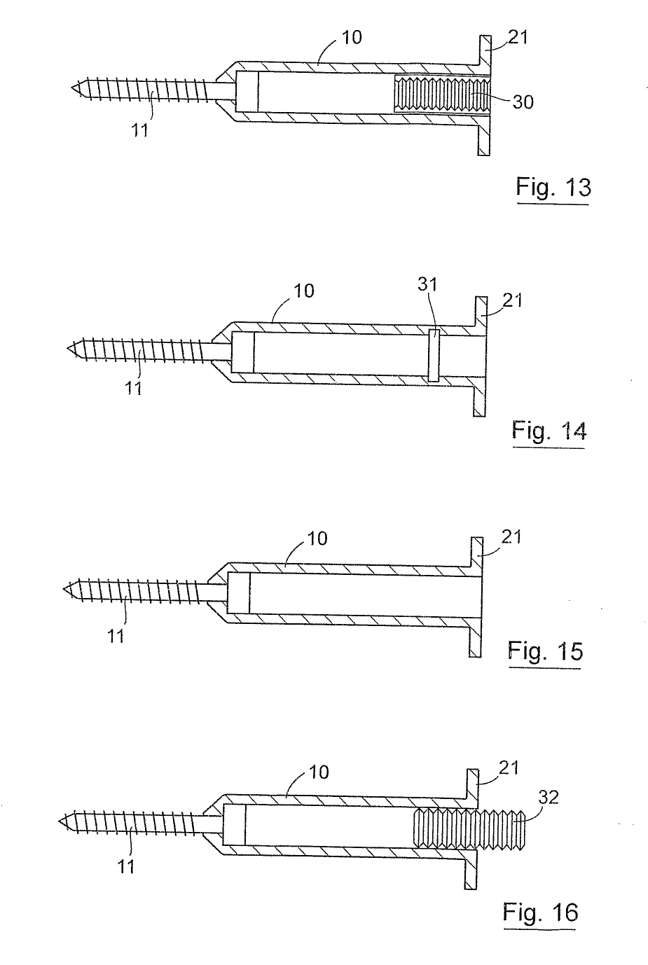

The spacer section 10 may be engagable in any suitable manner with the bracket fixing element 13. For example. the spacer section 10 may be provided with a threaded insert 30 [FIG. 13] or may be adapted at 31 to receive a bayonet type fixing [FIG. 14] or the fixing may be a push type [FIG. 15], or the fixing may be a threaded stud 32 to accept a nut fastener [FIG. 16].

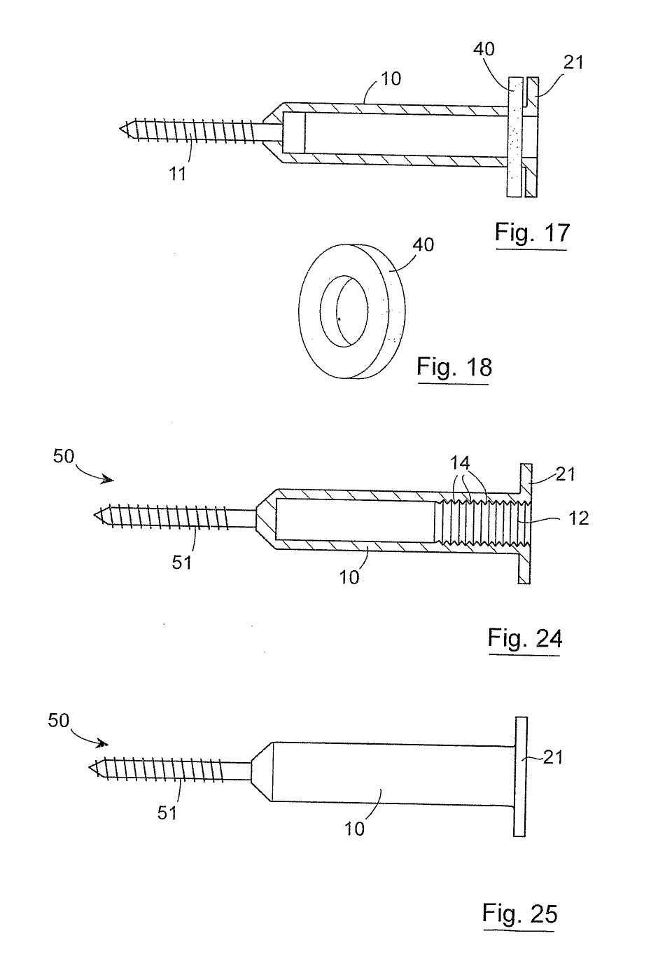

Preferably the spacer section 10 has an external self sealing washer 40 as illustrated in FIGS. 17 and 18. The washer 40 may be of any suitable material such as of a flexible polymer material.

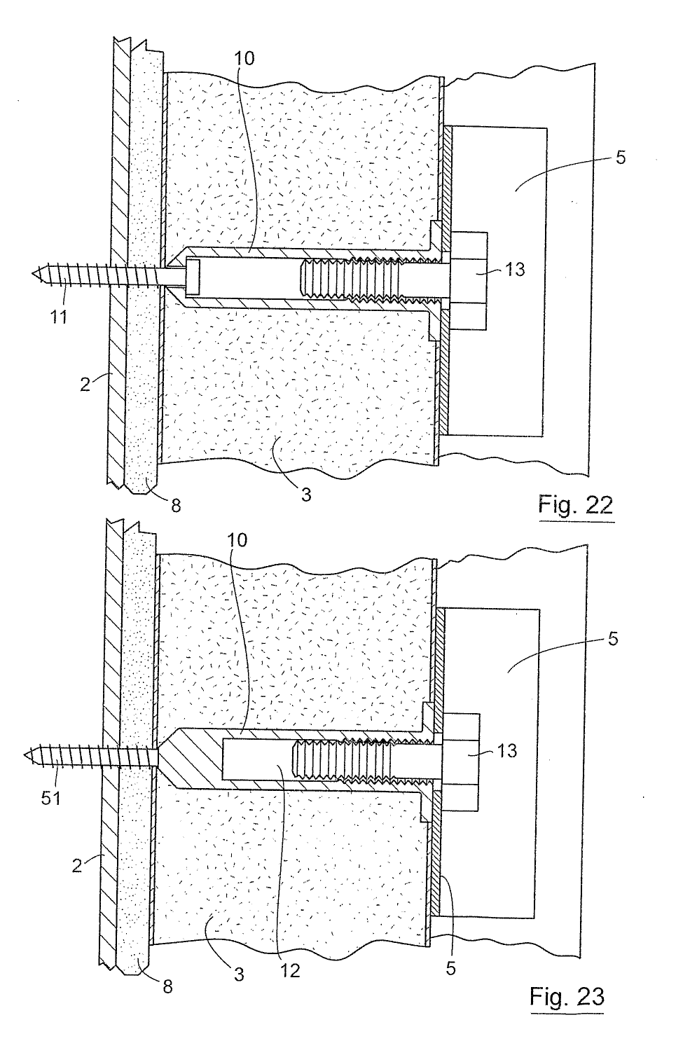

Referring to FIG. 22 the tapered end 20 of the spacer section 10 need not necessarily penetrate the sheathing 8.

Referring to FIGS. 23 to 25 there is illustrated another fixing 50. In this case a frame fixing screw 51 is integral with the spacer section 10. This may be of the same material as the spacer section 10, be mechanically or adhesively connected to the spacer section 10 or moulded unto the spacer.

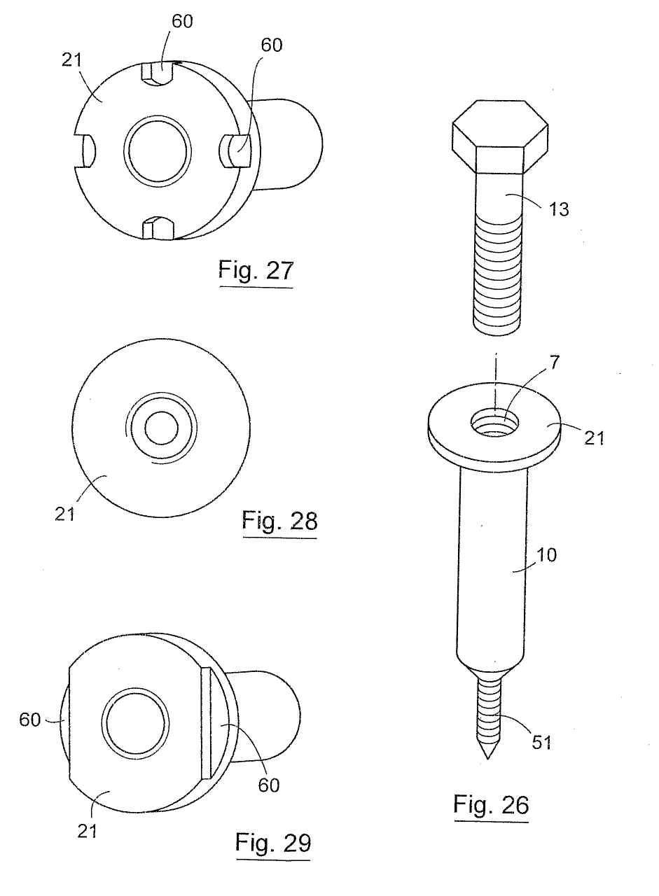

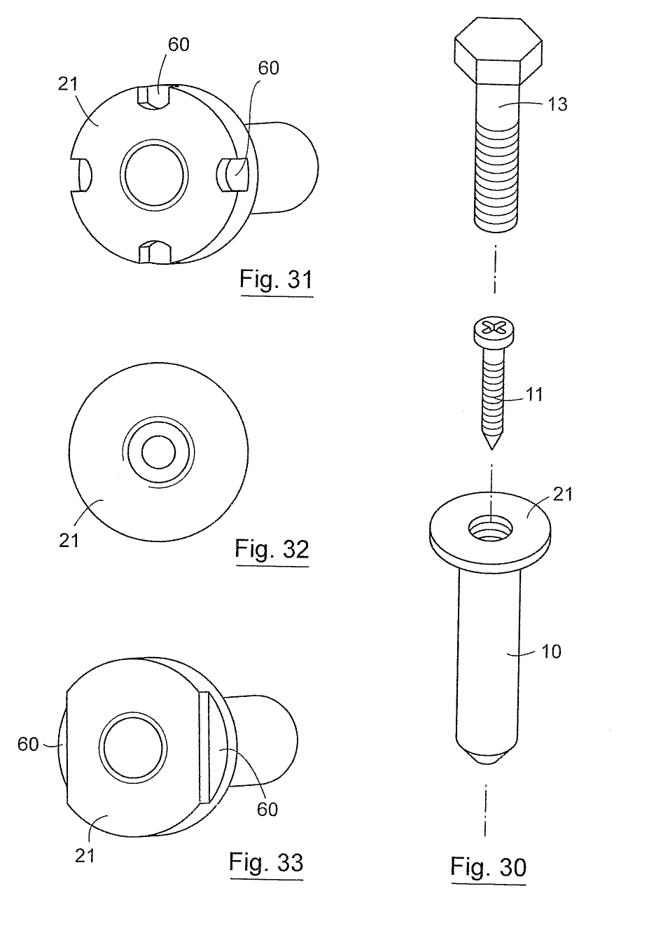

As illustrated in FIGS. 26 to 33 the head 21 of the spacer section 10 may be of any suitable form and may have engagement features 60 to enable a tool to be located to grip the spacer 10 and preventing rotation during tightening of the bracket bolt 13.

The assembly of the system involves pushing the hollow spacer section 10 through the insulation material 3. This can be done manually or be automated. A frame fixing screw 11 is then driven through the sheathing board 5 into the steel frame 2. A manufactured bracket 5 is then bolted to the flat head 21 of the spacer section 10 with a bolt 13. A number of the in-line brackets 5 are connected vertically with linear support element 7. The interface between the head 21 of the spacer section 10 and the bracket 5 acts as a moment resisting joint ensuring that load on the screw acts only in tension, compression and shear.

Referring to FIG. 20 in use of the fixing/spacing element loading L is applied downwardly on the bracket 5 due to gravity. This load is transmitted along the spacer element 10 to the screw 11 which acts in a shear direction S. Rotational moments M₁ and M₂ are resisted by resistance to rotation from the bracket connection element 7 (R1) and (R2) [FIG. 21]. Wind load W acts along the spacer 6.

The fixing and spacing element 6 supports a bracket 5 at the surface of the insulation. It may self penetrate the insulation layer or pre-formed holes may be provided. It also transfers loading to the frame 2 of the building.

Thermal performance is improved as the fixing/spacing element 6 may be of stainless steel and has a small conductive cross sectional area. Because the fixing 6 is at least partially self penetrating and symmetrical on its central axis it is easy to use and assembly is readily automated. The joint has improved mechanical performance as moments are resisted ensuring that only shear and axial stresses are applied.

The linear support element 7 may be of consistent cross section i.e. prismatic, or may vary in section along its length. The linear support element 7 may have an array of holes for connectivity or may be provided with other engagement features such as knurls, dogs, teeth and captive pins. The linear support element 7 may be of decorative nature to provide an architectural feature. The linear support element 7 may be formed from metal or polymer/reinforced polymer materials, or may be made from timber or other organic materials. The profile of the support element 7 can be of, but not limited to, the types shown in FIG. 34.

FIGS. 34(a) to 34(h) illustrate various cross sectional profiles of the linear bracket connecting element 7 used in system of the invention. The sections illustrated in FIGS. 34(a) to 34(d) are suitable for use with separate bracket elements. The brackets and support elements may be integral in a single unit. The sections illustrated in FIGS. 34(e) to 34(g) can be utilised to provide such integral brackets and connecting element.

The design of the spacer element/fixing lends itself to various manufacturing methods. It may be cold formed from tube, turned from bar, cast in metal or injection moulded from polymer or reinforced polymer material. Sintering or moulding of ceramic or vitreous materials may also be used. These materials may be used to further reduce thermal conductivity.

Many variations on the embodiments described will be readily apparent. Accordingly the invention is not limited to the embodiments hereinbefore described which may be varied in detail.

1-19. (canceled)

20. A support system for mounting building facade elements to a framework, the support system comprising:
a plurality of spaced-apart brackets;
a plurality of fixings for mounting the brackets to a framework,
the fixing comprising a generally cylindrical spacer section having a frame end and a bracket end, the spacer section having a flange at the bracket end,
a frame fixing element extending from the frame end of the spacer section for fixing to a framework and a bracket fixing element for extending from the bracket end of the spacer section for fixing to the bracket; and
a facade support element fixedly interconnecting in-line brackets.

21. The support system as claimed in claim 20 wherein the frame fixing element is a separate component from the spacer section.

22. The support system as claimed in claim 21 wherein the frame fixing element is held captive in the spacer section.

23. The support system as claimed in claim 21 wherein the frame fixing element is rotatably movable relative to the spacer section.

24. The support system as claimed in claim 21 wherein the frame fixing element is fixed relative to the spacer section.

25. The support system as claimed in claim 20 wherein the frame fixing element is integral with the spacer section.

26. The support system as claimed in claim 20 wherein the spacer section is at least partially hollow.

27. The support system as claimed in claim 26 wherein the spacer section is engagable with the bracket fixing element.

28. The support system as claimed in claim 27 wherein the spacer section is screw threadingly engagable with the bracket fixing element.

29. The support system as claimed in claim 20 wherein the spacer section has a small conductive cross sectional area.

30. The support system as claimed in claim 20 wherein the spacer section is of stainless steel.

31. The support system as claimed in claim 20 wherein the spacer section is of a polymer material, a reinforced polymer material, a ceramic material, or a vitreous material.

32. The support system as claimed in claim 20 wherein the frame fixing element is self penetrating through an insulation body.

33. The support system as claimed in claim 20 wherein the frame fixing element is self drilling and self tapping.

34. The support system as claimed in claim 20 comprising a washer which is engageable with the flange.

35. The support system as claimed in claim 34 wherein the washer is an external self sealing washer.

36. The support system as claimed in claim 20 wherein the brackets and the support element are integral in a single unit.

37. The cladding system incorporating a support system as claimed in claim 20.

38. A cladding system comprising:
a support framework;
an insulation body attached to the framework;
a plurality of spaced-apart brackets;
a support system as claimed in claim 1; and
facade elements mounted to the support element.
